(19) United States
(12) Patent Application Publication
(10) Pub. No.: US 2017/0068966 A1
(43) Pub. Date: Mar. 9, 2017

(54) SALES ANALYSIS SYSTEM OF ONLINE SHOPPING MALL AND ONLINE SALES ANALYSIS SERVER

(71) Applicants: Jungawoo NAM, Seoul (KR); Youngmi KIM, Seoul (KR)

(72) Inventor: Youngmi KIM, Seoul (KR)

(73) Assignees: Jungwoo NAM, Seoul (KR); Youngmi KIM, Seoul (KR)

(21) Appl. No.: 15/123,392

(22) PCT Filed: Feb. 13, 2015
(86) PCT No.: PCT/KR2015/001479

§ 371 Date: Sep. 2, 2016

(30) Foreign Application Priority Data
Mar. 4, 2014 (KR) 10-2014-0025596

(51) Int. Cl. G06Q 30/02; G06Q 30/06

(52) U.S. Cl. CPC G06Q 30/0201; G06Q 30/0641; G06Q 30/0633

(57) ABSTRACT

A system for analyzing sales of online shopping malls according to the present invention comprises a plurality of online shopping malls for generating a product page regarding a product being on sale in response to requests of customers accessing to the online shopping malls and providing the product page to the customers; and an analyzing server of online sales, wherein the analyzing server of online sales comprises: a contents transmitting unit for storing product contents included on the product page and providing the product contents to the plurality of online shopping malls at the request of the plurality of online shopping malls; and an inflow/sales analyzing unit for counting the number of times that the product contents have been transmitted from the contents transmitting unit to the plurality of online shopping malls.

### BACKGROUND OF THE INVENTION

1. Field of the Invention

The present invention relates to a sales analysis system of online shopping malls and an online sales analysis server. More specifically, the present invention relates to a technology that analyzes customer inflows and sales of the online shopping malls and provides the analysis results to sellers.

2. Description of the Related Art

Aided by spreading communication networks which are basis of online shopping malls, the online shopping malls have been increased. The online shopping mall, which is a representative electronic commerce using internet, is a mall implemented virtually on internet. The online shopping mall provides visitors with opportunities for analyzing and estimating a variety of goods displayed in the online mall and also comparing them with same goods of other malls. Therefore, the visitors connect to the internet and are able to buy goods easily what they want.

Meanwhile, sellers need to analyze correlations between an inflow figure of visitors and a sales figure, etc. for their products. According to a traditional sales analysis of online shopping mall, it analyzes internally the number of visitors using log data regarding access to mall homepage, inflow routes of visitors, and a correlation between the inflow figure of visitors and the sales figure. However, this system can check the inflow of visitors and sales figure for only one online shopping mall, in other words, check those things for only own shopping mall. For example, it enables to analyze about a variety of goods sold by one online shopping mall. Mostly, such analysis result of goods is used for planning a sales strategy by merchandiser (MD) who manages overall process from selecting goods to selling goods. However, the analysis result of goods is used exclusively for only own online shopping mall and it is not provided to sellers or manufacturers of the goods.

Recently, meanwhile, in many cases, one seller or manufacturer sells his goods only through his own shopping mall but also through online shopping malls like internet open markets, online department stores, home shopping channels, online major supermarkets and so on. To analyze the correlation between an inflow of visitors and a sales figure about goods which are sold, the seller or manufacturer needs to get the analysis result from each of online shopping malls and reanalysis it after reviewing the result. However, the online shopping mall does not have responsibility for providing the result of sales to sellers. For this reason, most of the online shopping malls do not provide their result of sales to sellers.

Therefore, for sellers who sell their goods through many online shopping malls, a system, which is to provide analysis results of the inflow of visitors into all online shopping malls and the sales figure from all online shopping malls, is required.

### SUMMARY OF THE INVENTION

An object of the present invention, which is to overcome aforementioned problems, is to provide a server and a system for analyzing inflow figures of customers and sales of the online shopping malls regarding a single product.

Another object of the present invention is to provide a server and a system for analyzing the inflow figures of customers and sales of the online shopping malls to count the number of transmissions that own information is transmitted to the online shopping malls without using personal information of customers or using inflow information received from the online shopping malls. Thus, the server and system could avoid conflicts caused by possession of information with the online shopping malls.

In accordance with one aspect of the present invention, provided is a system for analyzing sales of online shopping malls comprising: a plurality of online shopping malls for generating a product page regarding a product being on sale in response to requests of customers accessing to the online shopping malls and providing the product page to the customers; and an analyzing server of online sales, wherein the analyzing server of online sales comprises: a contents transmitting unit for storing product contents included on the product page and providing the product contents to the plurality of online shopping malls at the request of the plurality of online shopping malls; and an inflow/sales analyzing unit for counting the number of times that the product contents have been transmitted from the contents transmitting unit to the plurality of online shopping malls, receiving sales information of the product in the plurality of online shopping malls, and analyzing inflow figures of customers and sales figures for each product in all the online shopping malls or each of the online shopping malls with the transmitted information and the sales information; wherein the plurality of online shopping malls request the product contents included on the product page to the contents transmitting unit at the request of the customers and produce the product page.

In accordance with another aspect of the present invention, provided is an analyzing server of online sales for analyzing sales of product in online, which is connected with a plurality of online shopping malls, comprising: a contents transmitting unit for storing product contents included on a product page regarding a product on sale and providing the corresponding product contents to the online shopping mall at the request of the online shopping mall when a customer requests the product page to the online shopping mall; and an inflow/sales analyzing unit for counting the number of times that the product contents have been transmitted from the contents transmitting unit to the online shopping malls, receiving sales information of the product in the online shopping malls, and analyzing inflow figures of customers and sales figures for each product in all the online shopping malls or each of the online shopping malls with the transmitted information and the sales information.

As mentioned above, according to the present invention, the server and the system could analyze inflow figures of customers and sales of the online shopping malls regarding a single product.

In addition, the server and the system use a method that counts the number of times that own information is transmitted to the online shopping malls without using inflow information received from the online shopping malls. Thus, the server and the system could avoid conflicts caused by possession of information with the online shopping malls and also there is no worry for releasing personal information.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a conceptual block diagram to illustrate a concept of a system for analyzing sales of online shopping malls according to an embodiment of the present invention.

FIG. 2 is a block diagram for illustrating configuration of the system illustrated in FIG. 1 in more detail.

FIG. 3 illustrates an example of an initial screen of a web page provided to users (sellers) by an analyzing server of online sales according to an embodiment of the present invention.

FIG. 4 illustrates an example of an analysis result regarding all products being on sale of a particular seller according to an embodiment of the present invention.

FIG. 5 illustrates an example of an analysis result of inflow figures of customers and sales figures for each online shopping mall regarding a particular product according to an embodiment of the present invention.

FIG. 6 illustrates an example of an analysis result of advertisements, inflow figures of customers and sales figures regarding a particular product, which is analyzed using graphs based on periods, according to an embodiment of the present invention.

FIG. 7 illustrates a page per product, as an example of an analysis result for inflow figures of customers and sales figures of an analyzing server of online sales regarding a product according to an embodiment of the present invention.

FIG. 8 illustrates a page per product, as another example of an analysis result for inflow figures of customers and sales figures of an analyzing server of online sales regarding a product according to an embodiment of the present invention.

FIG. 9 is a simple flowchart that depicts an analyzing method of the system for analyzing sales of online shopping malls according to an embodiment of the present invention.

### DETAILED DESCRIPTION OF THE INVENTION

Hereinafter, exemplary embodiments of the present invention will be described in detail. However, the present invention is not limited to the exemplary embodiments disclosed below, but can be implemented in various forms. The following exemplary embodiments are described in order to enable those of ordinary skill in the art to embody and practice the invention.

It will be understood that, although the terms first, second, etc. may be used herein to describe various elements, these elements should not be limited by these terms. These terms are only used to distinguish one element from another. For example, a first element could be termed as a second element, and similarly, a second element could be termed as a first element, without departing from the scope of the present invention. The term and/or used herein includes any or all combinations of one or more of the associated listed items.

It will be understood that when an element is referred to as being connected or coupled to another element, it can be directly connected or coupled to the other element or intervening elements may be present.

The terminology used herein is for the purpose of describing particular embodiments only and is not intended to be limiting of the invention. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meanings as commonly understood by one of ordinary skill in the art to which this invention belongs. It will be further understood that terms, such as those defined in commonly uses dictionaries, should be interpreted as having a meaning that is consistent with their meaning in the context of the relevant art and will not be interpreted in an idealized or overly formal sense unless expressly so defined here.

Hereinafter, preferred embodiments of the present invention will be described in detail with the accompanying drawings. In the following description, the same reference numerals denote the same elements to facilitate the overall understanding, and repeated description thereof will be omitted.

Hereafter, the elements according to the present invention, which will be described by referring to figures, are those elements defined by functional classification not by physical classification. The elements according to the present invention could be defined by functions performed by each of the elements. Each of the elements could be implemented as hardware and/or program codes performing each function and processing units. They also could be implemented so that the functions of two or more elements are included in one element. Therefore, it needs to be noted that the names of elements, given in following embodiments, are not for distinguishing elements physically, for representing main function performed by each element. Furthermore, it needs to be noted that the spirit of the present invention is not be limited by the names of elements.

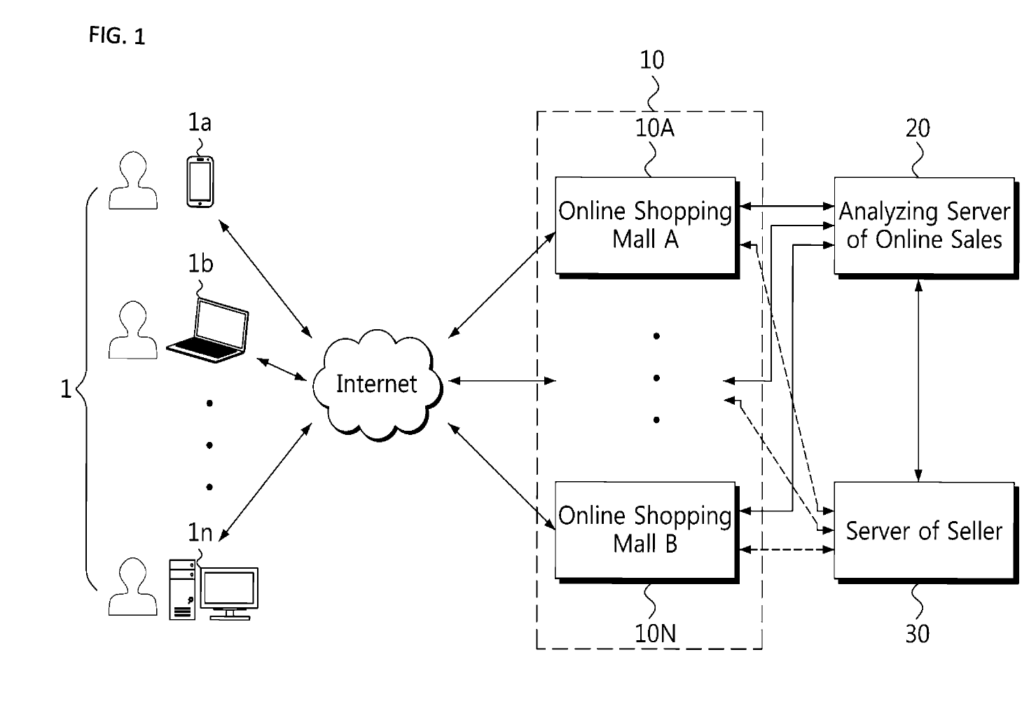

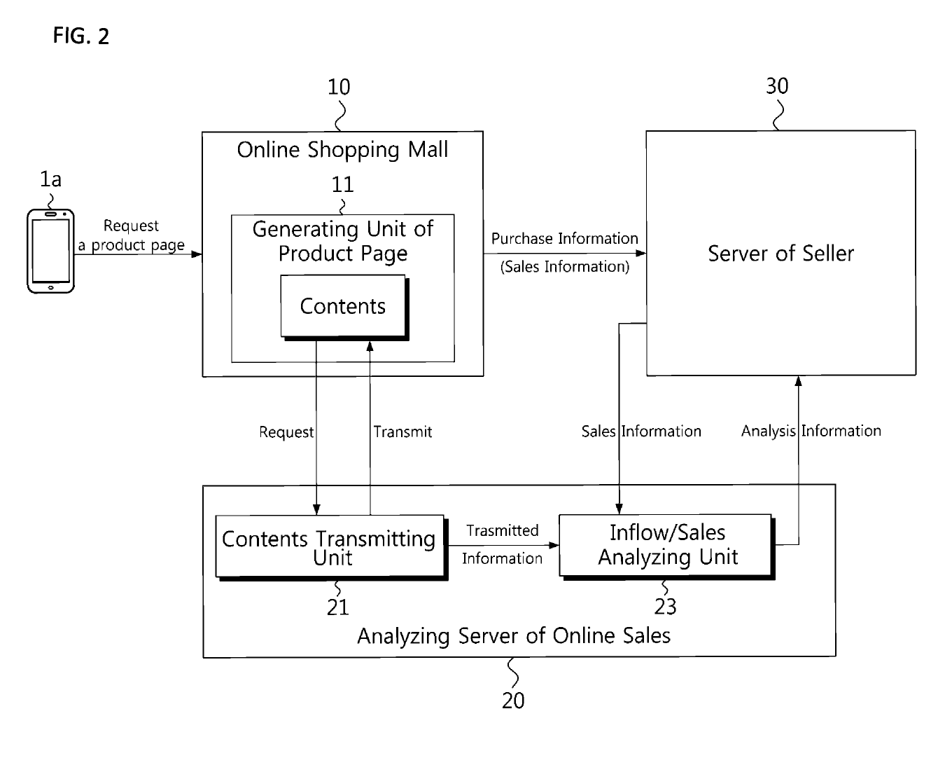

FIG. 1 is a conceptual block diagram to illustrate a concept of a system for analyzing sales of online shopping malls according to an embodiment of the present invention. FIG. 2 is a block diagram for illustrating configuration of the system illustrated in FIG. 1 in more detail.

Referring to FIG. 1, the system for analyzing sales of online shopping malls according to an embodiment of the present invention comprises a plurality of online shopping malls 10 and an analyzing server of online sales 20.

The online shopping malls 10 are sort of internet shopping malls or internet websites, which sell many products. The online shopping malls 10 generate product pages regarding products being on sale in response to requests of customers 1 accessing to the online shopping malls 10 and provide the product pages to customers 1 so that customers 1 are able to purchase products.

The online shopping mall 10 used herein has a broad meaning including all online websites providing information of products to sell products, which includes an agent server of online shopping malls. Referring to FIG. 2, the online shopping mall 10 includes a generating unit of product page 11 to generate the product page which is a sort of web page for introducing products being on sale.

The product page includes contents and frames. The online shopping mall 10 according to the present invention doesn't have contents regarding products. Whenever customers 1 request the product pages, the online shopping mall 10 requests corresponding product contents to the analyzing server of online sales 20. Sales information is provided to a seller, because the online shopping mall 10 instructs the seller to ship the product when the customer purchases the product.

The analyzing server of online sales 20, which is to analyze inflow figures of customers and sales figures of the online shopping malls 10, comprises a contents transmitting unit 21 and an inflow/sales analyzing unit 23.

The contents transmitting unit 21 stores product contents included on product pages. The product pages are web pages for introducing or displaying products being on sale. The contents transmitting unit 21 provides the product contents to the online shopping mall 10 in response to requests of the online shopping mall 10.

The contents transmitting unit 21 stores the product contents regarding the same product in diverse formats according to required formats for each of the online shopping malls 10 and provides the product contents corresponding to the online shopping malls 10 requiring the product contents. For example, each of the online shopping malls 10 may require product pages or product contents in different formats, so the contents transmitting unit 21 provides flash formats, JPG formats, etc. according to required formats.

The inflow/sales analyzing unit 23 counts the number of times that the product contents have been transmitted from the contents transmitting unit 21 to the online shopping malls 10, and receives the sales information of products in the plurality of online shopping malls 10. The inflow/sales analyzing unit 23 analyzes inflow figures of customers and sales figures for each product in all the online shopping malls 10 or each of the online shopping malls 10 with the transmitted information and the sales information.

The transmitted information includes date and time when the product contents are transmitted, online shopping malls 10 where the product contents are transmitted, the number of transmissions, and IP address of receiver.

The inflow/sales analyzing unit 23 analyzes the inflow figures of customers of the corresponding online shopping mall 10 by counting the number of times that the product contents have been transmitted to the online shopping mall 10.

According to the existing technology, the number of times that the product contents have been clicked in the online shopping malls 10 is regarded as the inflow figures of customers into the online shopping mall 10. Moreover, the information regarding inflow figures of customers was possessed by only relevant online shopping mall 10.

On the other hand, according to the present invention, the analyzing server of online sales 20 possesses the product contents, not the online shopping mall 10. Whenever customers 1 click products on web pages of online shopping mall, the online shopping mall 10 requests the product contents included on the product page to the analyzing server of online sales 20. The analyzing server of online sales 20 transmits the corresponding product contents and also counts the number of transmissions. Thus, the analyzing server of online sales 20 is able to obtain information regarding inflow figures of customers, indirectly and also correctly.

Referring to FIG. 1 and FIG. 2, according to an embodiment of the present invention, the system for analyzing sales of online shopping malls could further comprise a server of seller 30 like manufacturers or vendor of products.

The server of seller 30 is a server to receive shipment orders of the products or sales information from the online shopping mall 10 when customers purchase the products on the online shopping mall 10. The server of seller 30 transmits the sales information of products to the server for analyzing online sales 20 based on the shipment orders or the sales information of products and receives analysis results regarding the inflow figures of customers and sales figures for each product or each online shopping mall from the server analyzing online sales 20. Meanwhile, the server of seller 30 can transmit the sales information of products once a day, that is, the server of seller 30 can transmit the daily sales information of product to the analyzing server of online sales 20 or can transmit the sales information to the analyzing server of online sales 20, whenever sales are generated.

The sales information includes date and time when the product was sold, sales figures of the product, price of the product, and online shopping malls where the product was sold.

According to the embodiment mentioned above, it has been explained that the sales information is transmitted from the server of seller 30 to the analyzing server of online sales 20, in some cases, however, the sales information can be transmitted directly from the online shopping mall 10 to the analyzing server of online sales 20.

Furthermore, the analyzing server of online sales 20 could store various information related to products in addition to the product contents and provide various analysis results regarding the inflow figures of customers and sales figures based on the stored various information. For example, the analyzing server of online sales 20 could store information including mediums of advertisement, a period of advertisement, the number of times of advertisement, and categories of products such as TV, irons, vacuum cleaners, kitchen appliances, etc.

The analyzing server of online sales 20 is able to be implemented as a sort of web system. The analyzing server of online sales 20 is able to store the product contents and the various information regarding products for each seller or each product. Therefore, taking a plurality of sellers as customers, the analyzing server of online sales 20 could provide analysis services regarding sales to each seller. Connecting to the web system, the sellers can analyze what they want after registering ID and password. The analyzing server of online sales 20 provides services so that users, that is, the sellers, who have been connected to the web system, can do various analyses regarding products for each product, each category, or each online shopping mall.

The analyzing server of online sales 20 may store the product contents and various information regarding products mentioned above by using processed information which has been processed from information received from the sellers by a manager of analyzing server of online sales 20.

In some cases, the sellers, who have been connected to the analyzing server of online sales 20, can enter directly the product contents and various information regarding products into the analyzing server of online sales 20. In other cases, the analyzing server of online sales 20 could be applied to the server of seller 30.

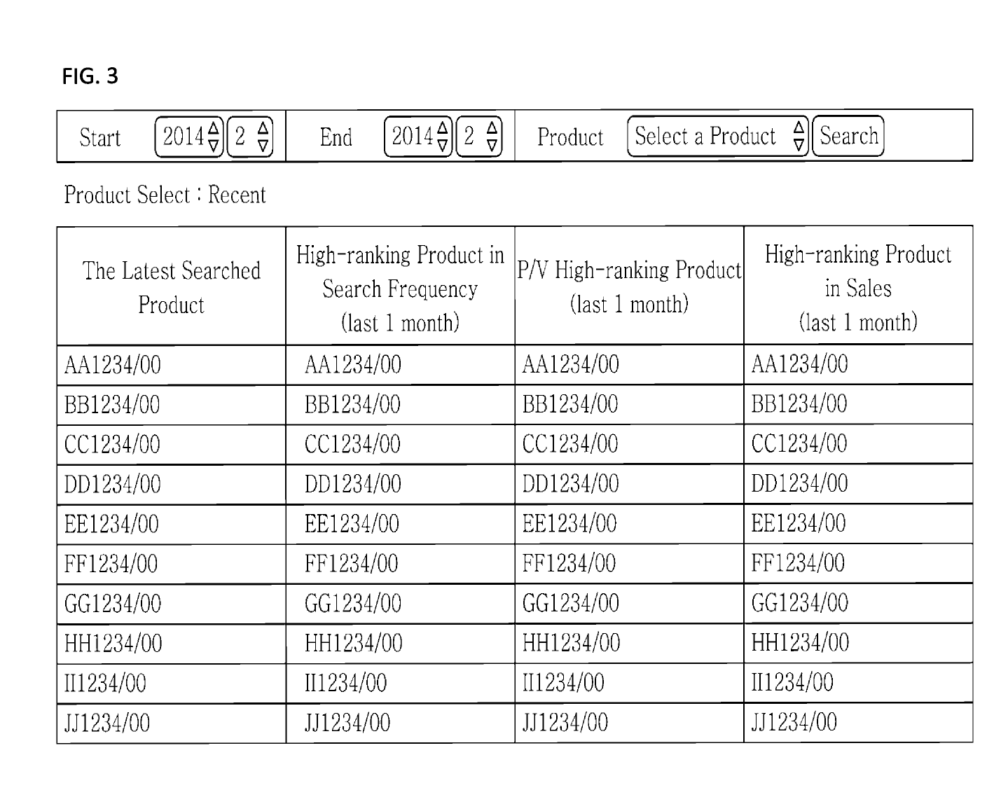

FIG. 3 illustrates an example of an initial screen of a web page provided to users (sellers) by the analyzing server of online sales 20 according to an embodiment of the present invention. The initial screen could be implemented to provide various lists of product types, search frequency, high-ranking products in inflow figures of customers, and high-ranking products in sales, so that the users can search products in various views.

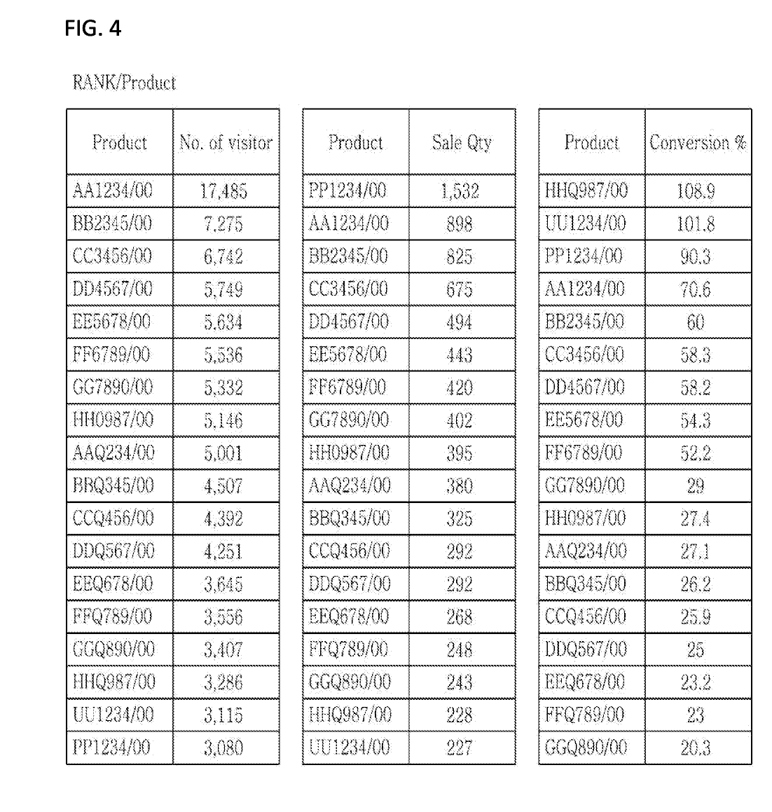

FIG. 4 illustrates an example of an analysis result regarding the inflow figures of customers and sales figures of the analyzing server of online sales 20, which is analyzed for all products of a particular seller.

A particular seller can sell from several to hundreds, even thousands, of products. FIG. 4 illustrates a part of analysis result that has analyzed inflow figures of customers (No. of visitor), sales (Sale Qty), and conversion rates (Conversion) for products of all the online shopping malls 10. The conversion rates mean rates of inflow figures that have been converted into sales. Referring to FIG. 4, an order of the inflow figures of customers is AA1234/00, followed by BB2345/00, and CC3456/00. An order of sales is PP1234/00, followed by AA1234/00, and BB2345/00, and an order of the conversion rates is HHQ987/00, followed by UU1234/00, and PP1234/00. The codes, such as AA1234/00, etc. are unique codes of products, such as names of product model or product code, etc.

The inflow/sales analyzing unit 23 of the analyzing server of online sales 20, in addition to analyze the inflow figures of customers and sales figures of products, is able to analyze a correlation between the sales figures and the inflow figures of customers according to advertising expenses of each product in a certain period, the number of advertisements, etc. The advertisements include TV direct advertising, PPL, online advertising, etc.

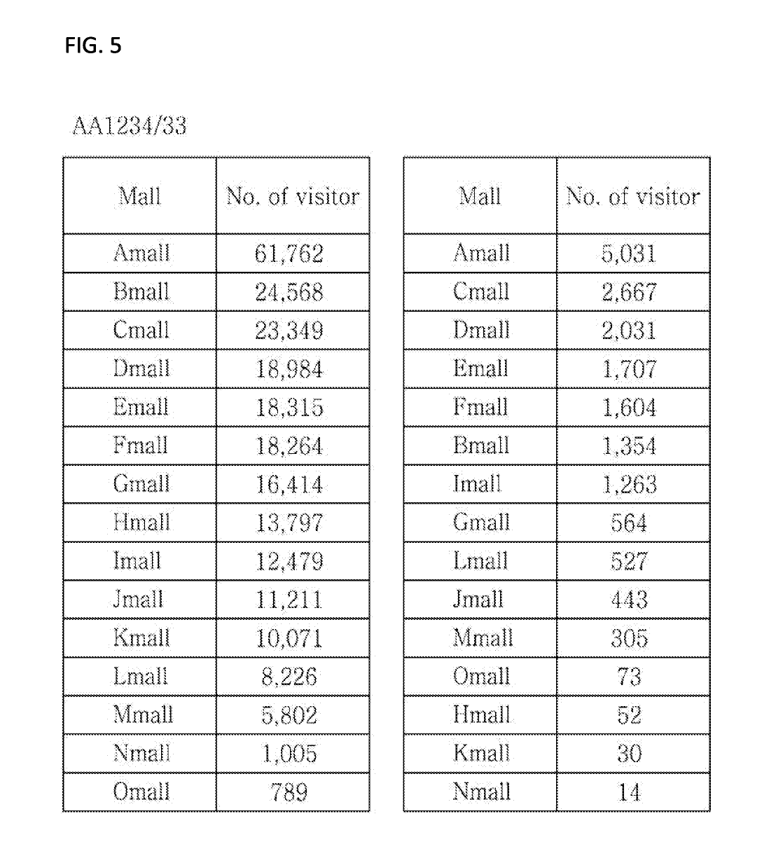

FIG. 5 illustrates an example of an analysis result regarding the inflow figures of customers and sales figures of the analyzing server of online sales 20, which is analyzed for each of the online shopping malls 10 regarding a particular product.

Referring to FIG. 5, an order of the inflow figures of customers regarding the product AA1234/33 is A mall, followed by B mall, and C mall. On the other hand, an order of the sales figures of online shopping malls is A mall, followed by C mall and D mall, which is a little bit different from the order of the inflow figures of customers.

The analyzing server of online sales 20 can analyze proportion of each of the online shopping malls in the total inflow figures of customers and the total sales. Furthermore, considering advertising expenses and the number of advertisements for the corresponding product in each online shopping mall 10, the analyzing server of online sales 20 can analyze a correlation between the sales figures and the inflow figures of customers according to advertising expenses of each product in a certain period, the number of advertisements, etc.

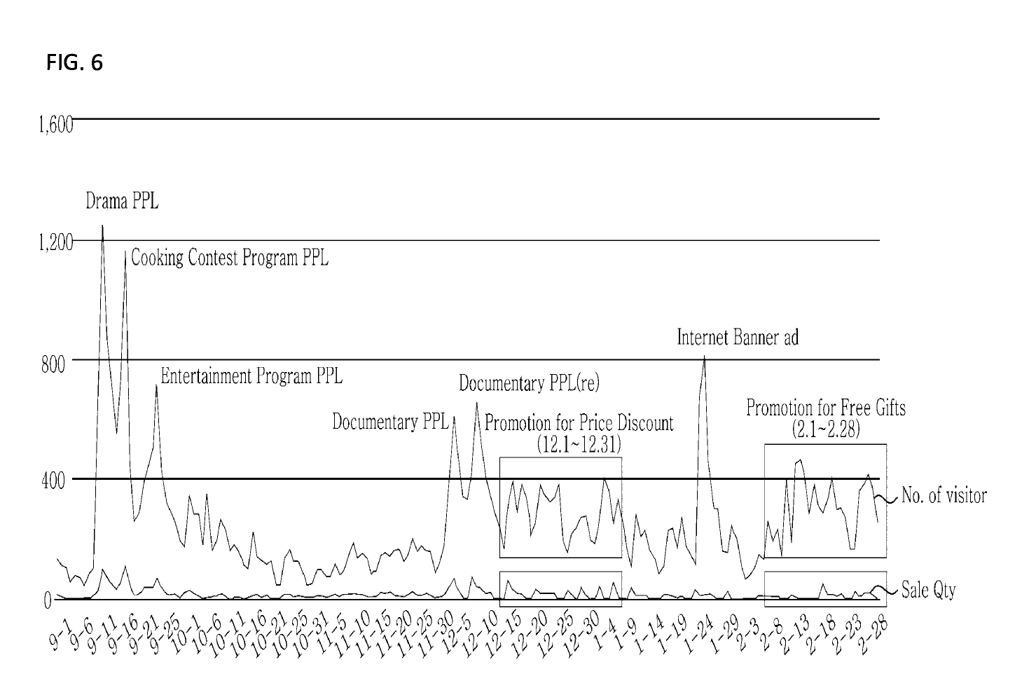

FIG. 6 illustrates an example of an analysis result regarding the inflow figures of customers and sales figures of the analyzing server of online sales 20, which analyzes advertisements, inflow figures of customers, sales figures for a particular product using graphs based on periods. Referring to FIG. 6, it has been analyzed that the inflow figures of customers have a significant relationship with the sales for the product AA1234/00. Furthermore, when associating the inflow figures with advertisements, it has been analyzed that the effect of advertisements has a strong influence on the inflow figures of customers. The establishment of a period for analysis can be based on choice of the user, such as a day, a week, a month. Thus the user can analyze on various periods.

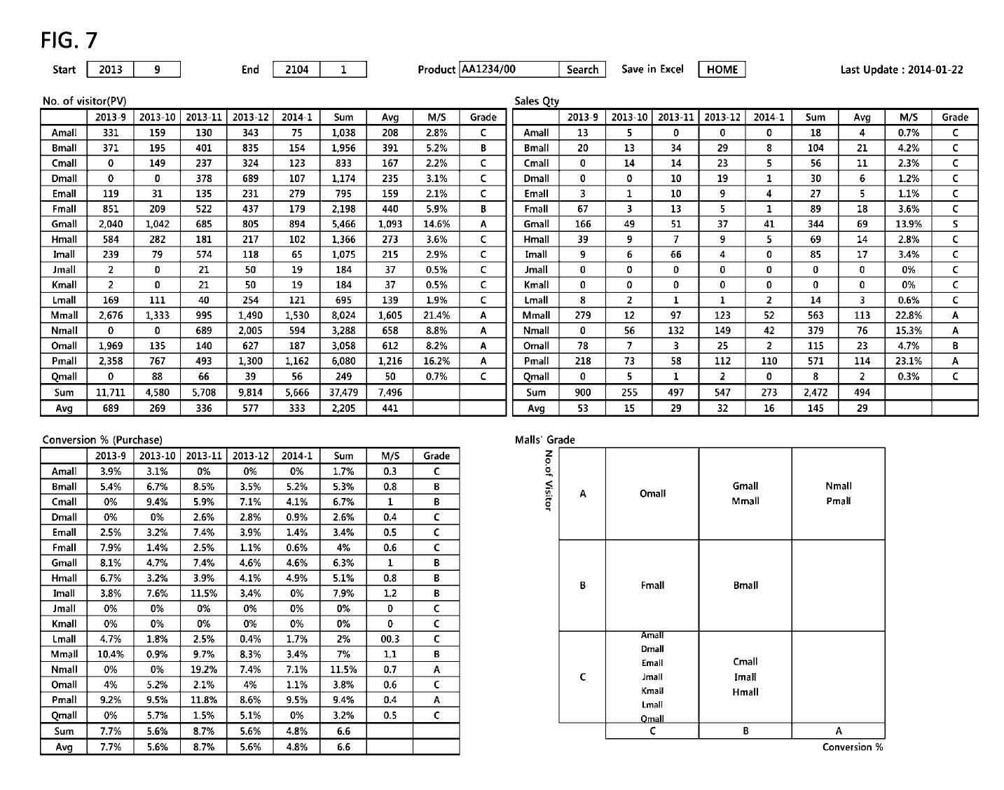

FIG. 7 illustrates a page per product, as an example of an analysis result of inflow figures of customers and sales figures of an analyzing server of online sales 20 regarding a product. Referring to FIG. 7, on the page per product, monthly inflow figures of customers, sales figures, conversion rates, ranking of online shopping malls, and grades of online shopping malls have been analyzed.

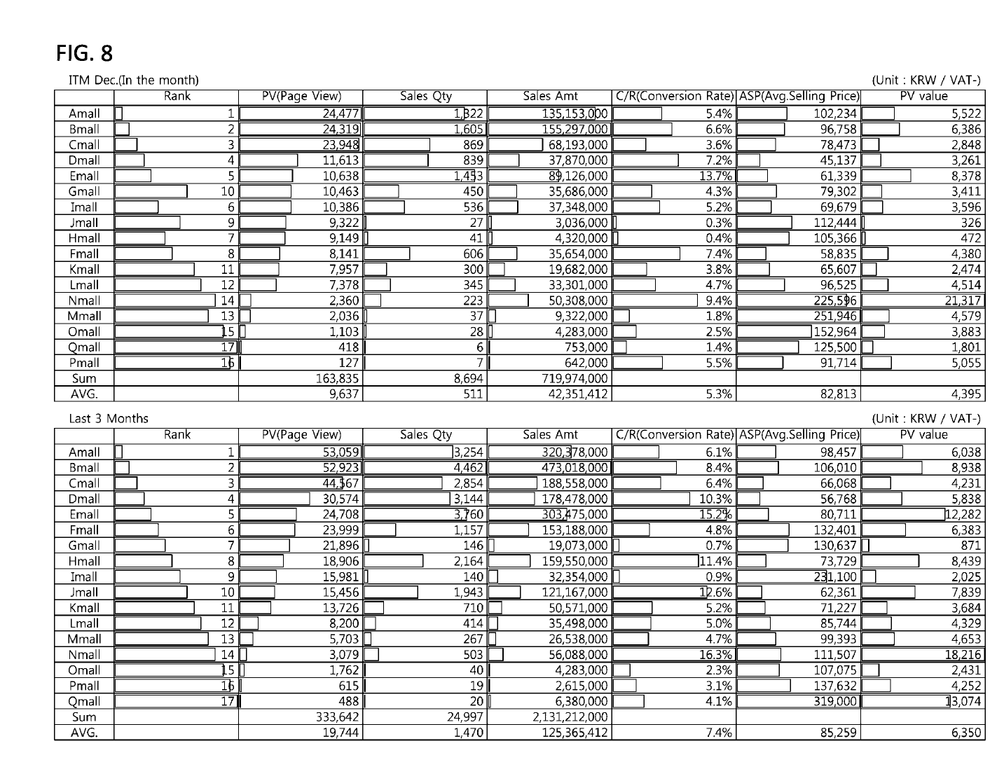

FIG. 8 illustrates another example of page per product, as an example of an analysis result of inflow figures of customers and sales figures of an analyzing server of online sales 20 regarding a product. Referring to FIG. 8, it shows graphs that are results of analyzing a ranking of online shopping malls 10 ordered by rates of sale for selected period like the latest month, the latest three months, the inflow figures of customers (Page view), the sales figures, the sale revenue, the conversion rate (sales figures divided by inflow of figures of customers), the average sale price (sales price divided by sales figures), the values of inflow (sales price divided by inflow of figures of customers), etc.

The seller, who is a customer of the analyzing server of online sales 20, can obtain various analysis information regarding effects of advertising for product and online shopping malls that need to be focused based on the results mentioned above, and can use the analysis information on marketing.

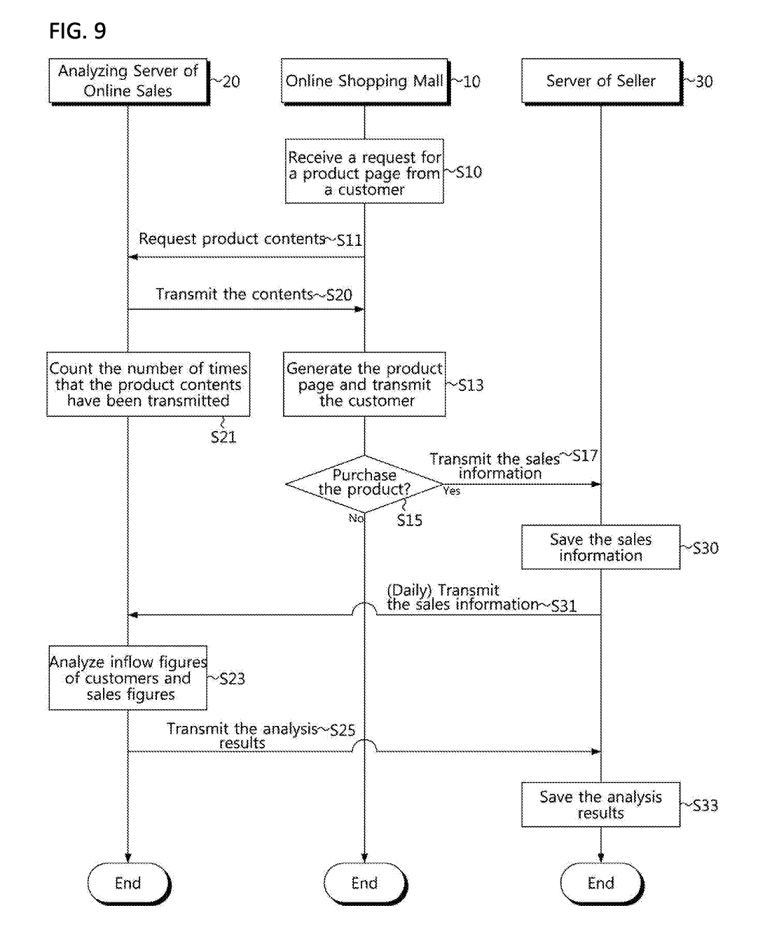

FIG. 9 is a simple flowchart that depicts an analyzing method of the system for analyzing sales of online shopping malls according to an embodiment of the present invention.

Referring to FIG. 9, in step S10, if a customer 1 accessing to webpages of online shopping mall requests a product page, the online shopping mall 10 requests product contents included on the product page to the analyzing server of online sales 20 in step S11.

In step 20, the analyzing server of online sales 20 transmits the product contents to the online shopping mall 10 at the request of the online shopping mall 10. After that, in step 21, the analyzing server of online sales 20 counts the number of transmissions. The transmitted information includes types of product contents, online shopping malls where the product contents are transmitted, and time when the product contents are transmitted, etc. And then, the analyzing server of online sales 20 saves the counted results.

In step S13, the online shopping mall 10 receives the product contents, generates a product page of the contents according to a certain frame, and provides the product page to the customer 1. In step 15, if the customer 1 purchases a product, the online shopping mall 10 transmits a shipment order or sales information of that product to the server of seller 30 in step S17.

In step S30, the server of seller 30 saves the sales information according to the shipment order received from the online shopping mall 10. In step S31, whenever sales are generated, the server of seller 30 transmits the sales information of product to the analyzing server of online sales 20. Or the server of seller 30 collects the sales information for a day and transmits the collected sales information

The analyzing server of online sales 20 analyzes variously inflow figures of customers, sales figures, conversion rates, values of inflow, a correlation with advertisements, etc. for each product, each seller, each product category, or each online shopping mall, based on the transmitted information regarding the product contents transmitted to the online shopping mall 10 and the sales information transmitted from the server of seller 30. And then, the analyzing server of online sales 20 transmits the analysis results to the server of seller 30.

As mentioned above, in a case that the analyzing server of online sales 20 is implemented as a web system, the seller accesses to the analyzing server of online sales 20 and can check the various analysis results for each product, each period, each online shopping mall.

In the past, information regarding the inflow figures of customers of product had been monopolized by online shopping malls. However, according to the present invention, the information regarding inflow figures of customers is obtained by counting the number of times that the product contents have been transmitted. Thus, it is able to obtain information regarding inflow figures of customers, indirectly and also correctly. In addition, based on the information of inflow figures of customers, it analyzes the inflow figures of customers and sales for each of the online shopping malls or all the online shopping malls in various views. Therefore, it is able to provide sellers with data which is actually helpful for planning a marketing strategy.

While the invention has been shown and described with reference to certain exemplary embodiments thereof, it will be understood by those skilled in the art that various changes in form and details may be made therein without departing from the spirit and scope of the invention as defined by the appended claims.

1. A system for analyzing sales of online shopping malls, comprising:
a plurality of online shopping malls for generating a product page regarding a product being on sale in response to requests of customers accessing to the online shopping malls and providing the product page to the customers; and
an analyzing server of online sales,
wherein the analyzing server of online sales comprises:
a contents transmitting unit for storing product contents included on the product page and providing the product contents to the plurality of online shopping malls at the request of the plurality of online shopping malls; and
an inflow/sales analyzing unit for counting the number of times that the product contents have been transmitted from the contents transmitting unit to the plurality of online shopping malls, receiving sales information of the product in the plurality of online shopping malls, and analyzing inflow figures of customers and sales figures for each product in all the online shopping malls or each of the online shopping malls with the transmitted information and the sales information;
wherein the plurality of online shopping malls request the product contents included on the product page to the contents transmitting unit at the request of the customers and produce the product page.

2. The system according to claim 1, wherein the transmitted information includes date and time when the product contents are transmitted, online shopping malls where the product contents are transmitted, the number of transmissions, and IP address of receiver.

3. The system according to claim 1, wherein the sales information includes date and time when the product was sold, sales figures of the product, price of the product, and online shopping malls where the product was sold.

4. The system according to claim 1,
wherein the contents transmitting unit stores the diverse product contents regarding the same product in accordance with required formats of each of the online shopping malls and provides the product contents according to the online shopping malls at the request of the online shopping malls.

5. The system according to claim 1,
wherein the inflow/sales analyzing unit analyzes the inflow figures of customers by counting the number of times that the product contents have been transmitted to the online shopping malls.

6. The system according to claim 1, wherein the system further comprises a server of seller for receiving shipment orders of the products from the online shopping malls when the customers purchase the products on the online shopping malls,
wherein the server of seller transmits the sales information of the products to the analyzing server of online sales based on the shipment orders and receives analysis results regarding the inflow figures of customers and sales figures for each product from the analyzing server of online sales.

7. An analyzing server of online sales for analyzing sales of product in online, which is connected with a plurality of online shopping malls, comprising:
a contents transmitting unit for storing product contents included on a product page regarding a product on sale and providing the corresponding product contents to the online shopping mall at the request of the online shopping mall when a customer requests the product page to the online shopping mall; and
an inflow/sales analyzing unit for counting the number of times that the product contents have been transmitted from the contents transmitting unit to the online shopping malls, receiving sales information of the product in the online shopping malls, and analyzing inflow figures of customers and sales figures for each product in all the online shopping malls or each of the online shopping malls with the transmitted information and the sales information.

8. The analyzing server of online sales according to claim 7,
wherein the inflow/sales analyzing unit analyzes the inflow figures of customers by counting the number of times that the product contents have been transmitted to the online shopping malls.

9. The system according to claim 2,
wherein the contents transmitting unit stores the diverse product contents regarding the same product in accordance with required formats of each of the online shopping malls and provides the product contents according to the online shopping malls at the request of the online shopping malls.

10. The system according to claim 2,
wherein the inflow/sales analyzing unit analyzes the inflow figures of customers by counting the number of times that the product contents have been transmitted to the online shopping malls.

11. The system according to claim 2, wherein the system further comprises a server of seller for receiving shipment orders of the products from the online shopping malls when the customers purchase the products on the online shopping malls,
wherein the server of seller transmits the sales information of the products to the analyzing server of online sales based on the shipment orders and receives analysis results regarding the inflow figures of customers and sales figures for each product from the analyzing server of online sales.
